(19) United States
(12) Patent Application Publication
(10) Pub. No.: US 2026/0147175 A1
(43) Pub. Date: May 28, 2026

(54) COMMUNICATIONS FRAME WITH CASSETTES

(71) Applicant: CommScope Technologies LLC, Claremont, NC (US)

(72) Inventors: John Paul ANDERSON, Eden Prairie, MN (US); Kamlesh G. PATEL, Chanhassen, MN (US); John T. PFARR, Le Sueur, MN (US); Scott C. SIEVERS, Jordan, MN (US); Olivia M. ROBERTS, Plymouth, MN (US); David Jan Irma VAN BAELEN, Winksele (BE)

(73) Assignee: CommScope Technologies LLC, Claremont, NC (US)

(21) Appl. No.: 19/120,593

(22) PCT Filed: Oct. 13, 2023
(86) PCT No.: PCT/US2023/076901

§ 371 Date: Apr. 11, 2025

Related U.S. Application Data
(60) Provisional application No. 63/379,558, filed on Oct. 14, 2022.
(60) Provisional application No. 63/578,750, filed on Aug. 25, 2023.

(51) Int. Cl. G02B 6/44

(52) U.S. Cl. CPC G02B 6/4455; G02B 6/4452

(57) ABSTRACT

A communications panel is configured to hold a plurality of cassettes via tray elements. The cassettes can be pre-mounted to the tray elements before being loaded into the panel. Alternatively, the tray elements can be loaded into the panel prior to installing the cassettes on the tray elements. Some types of tray elements route rear cables (e.g., input cables) of the cassettes to the front of the communications panel. Some types of cassettes route the rear/input cable to the front of the panel. Some types of tray elements (i.e., trays) hold more than one cassette. Other types of tray elements (i.e., cassette managers) hold only one cassette each. Some types of cassette managers define a cable routing path along a common side with the cassettes. Other types of cassette managers define the cable routing path along an opposite side from the cassette.

### CROSS-REFERENCE TO RELATED APPLICATIONS

This application is being filed on Oct. 13, 2023, as a PCT International Application and claims the benefit of U.S. Provisional Application No. 63/379,558, filed Oct. 14, 2022, and U.S. Provisional Application No. 63/578,750, filed Aug. 25, 2023, the disclosures of which are hereby incorporated by reference in their entireties.

### BACKGROUND

In the telecommunications industry, the demand for added capacity is growing rapidly. This demand is being met in part by the increasing use and density of fiber optic transmission equipment. Even though fiber optic equipment permits higher levels of transmission in the same or smaller footprint than traditional copper transmission equipment, the demand requires even higher levels of fiber density. This has led to the development of high-density fiber handling equipment.

In communications panel systems, port members (e.g., optical adapters, electrical jacks, hybrid port members, etc.) defining front ports are mounted to panels that are typically frame or rack mounted. The front ports are configured to receive plug connectors at the fronts of the panels. In certain implementations, the port members can be mounted to one or more trays that are disposable within a chassis of the panel. The trays can either be stationary within a chassis or can slide forwardly of the chassis to enhance access to the port members. Various concerns exist for the communications distribution systems, including density, ease of use, and cable management. There is a continuing need for improvements in the optical fiber distribution area.

### SUMMARY

In accordance with aspects of the disclosure, one or more cassettes can be mounted at a communications frame. For example, the one or more cassettes can be removably mounted within a chassis, which is mounted to the communications frame. The communications frame may hold one or more such chassis. In certain implementations, the cassettes are mounted to the chassis via one or more tray elements.

In certain implementations, when the cassette is mounted to the tray element, the tray element and the cassette move together as a unit referred to herein as a cassette unit. In some examples, the cassette units are mountable to the chassis. In other examples, the tray elements can be first mounted to the chassis and the cassettes can be subsequently mounted to the tray elements.

In some implementations, the cassette units are mounted vertically within the chassis. In other implementations, the cassette units are mounted horizontally within the chassis.

In some implementations, a tray element includes a tray configured to hold multiple cassettes. In other implementations, a tray element includes a cassette manager configured to hold only a single cassette. In some examples, the cassette manager routes the cable(s) along the same surface to which the cassette is mounted. In other examples, the cassette manager routes the cable(s) along an opposite surface.

In certain examples, the cassettes receive the input and output cables at different ends of the cassettes. However, the cassette units (and hence the chassis) are configured for front-access only. In certain examples, both input and output cables for the cassette(s) are routed to a front of the cassette unit.

In certain implementations, a communications panel includes a chassis holding one or more trays. Each tray is configured to support one or more cassettes carrying exteriorly accessible ports (e.g., optical ports, electrical ports, or hybrid ports) to receive plug connectors. The cassettes are slidably mounted to the tray along guides. Certain types of cassettes receive cables so that connectors terminating first ends of the cables are disposed within the cassettes and connectors terminating opposite second ends of the cables are disposed external of the cassettes.

In certain implementations, the cable enters the cassette at a common side of the cassette with the exteriorly accessible ports. In certain examples, the cable enters the cassette between adjacent port members. In certain examples, the cable enters the cassette from a front of the cassette along a central longitudinal axis.

In certain implementations, a portion of the cable is configured to be paid out from the cassette. In certain examples, the cable can be paid out through a boot or other strain relief member fixed to the cassette. In certain examples, the cable is paid out from the cassette by pulling on the exterior connectorized end of the cable.

In certain examples, the cassette includes a storage region at a rear of the cassette. An intermediate portion of the cable is stowed at the storage region. As the cable is paid out, the intermediate portion of the cable is unwound or otherwise pulled out of the storage region. In certain examples, the cable extends along a central longitudinal axis of the cassette between the storage region and the front of the cassette.

In certain examples, the cable is anchored to the cassette at an anchor station so that a portion of the cable remains fixed relative to the cassette while another portion of the cable is paid out from the cassette. Pulling on the connectorized end will only move the portion of the cable extending between the anchor station and the connectorized end. The portion of the cable extending between the anchor station and interior ports of the cassette remains unaffected by load on the connectorized end.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic diagram of an example communications frame holding a plurality of communications panels that each hold a plurality of cassettes mounted to tray elements;

FIG. 2 is a perspective view of a first example communications panel including a tray element holding a plurality of cassettes and a cable routing guide;

FIG. 3 is an exploded view of the communications panel of FIG. 2 shown with only one cassette for ease in viewing;

FIG. 4 is a top plan view of the communication panel of FIG. 2 shown with only one cassette for ease in viewing;

FIG. 5 is a front elevational view of an example cassette suitable of use in any of the communication panels disclosed herein;

FIG. 6 is a perspective view of an example cable guide member suitable for use with the tray element of FIG. 2;

FIG. 7 is a perspective view of a first example cassette unit including a cassette mounted to another example tray element, the first cassette unit being configured for cable routing;

FIG. 8 is an exploded view of the first cassette unit of FIG. 7;

FIG. 9 is a rear perspective view of the tray element of FIG. 7;

FIG. 10 is a perspective view of a second example communications panel holding the first cassette units of FIG. 7;

FIG. 11 is a top plan view of the second communications panel of FIG. 10 with the top removed for ease in viewing the first cassette units;

FIG. 12 is a perspective view of a second example cassette unit including a cassette mounted to another example tray element, the second cassette unit being configured for cable routing;

FIG. 13 is an exploded view of the second cassette unit of FIG. 12;

FIG. 14 is a perspective view of a partially loaded third communications panel configured to hold the second cassette units of FIG. 12;

FIG. 15 is a perspective view of the third communications panel of FIG. 14 fully loaded;

FIG. 16 is a perspective view of an example communications panel system including a chassis mounted to a rack, the chassis being configured to hold a plurality of tray arrangements to which one or more cassettes can mount;

FIG. 17 is a perspective view of an example tray arrangement configured to be mounted within the chassis of FIG. 16, the tray arrangement including a tray carrying a plurality of guides;

FIG. 18 is a top perspective view of an example cassette suitable for mounting to the tray arrangement of FIG. 16;

FIG. 19 is a bottom perspective view of the cassette of FIG. 18;

FIG. 20 is a top plan view of the cassette of FIG. 18 with a cover removed for ease in viewing the interior;

FIG. 21 shows the cassette of FIG. 18 with the cover exploded outwardly from the cassette for ease in viewing the interior;

FIG. 22 shows components of the cassette exploded away from each other along a central longitudinal axis of the cassette;

FIG. 23 is a perspective view of an example cassette piece suitable for use in forming the cassette of FIG. 18;

FIG. 24 is a perspective view of a latch of the cassette piece of FIG. 23;

FIG. 25 is a side elevational view of the latch of FIG. 24; and

FIG. 26 is a front elevational view of the latch of FIG. 24.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

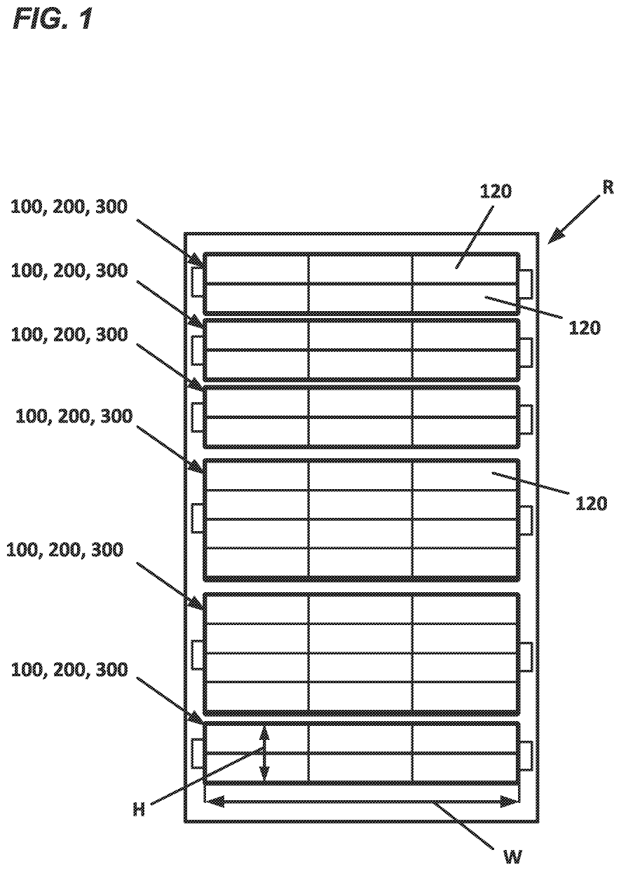

FIG. 1 illustrates an example frame R configured to hold one or more communications panels 100. Each communications panel 100, 200, 300 is configured to hold one or more cassettes 120. In certain implementations, one or more of the cassettes 120 mount to a tray element 115. In some examples, the tray element 115 is configured to hold a plurality of cassettes 120. In some such examples, the tray element 115 extends across a width W of the panel 100. In other examples, the cassettes 120 are each mounted to a respective tray element 115 that retains the cassette 120 within the communications panel 200, 300. In some such examples, multiple tray elements 115 are disposed in one or more rows across the width W of the panel 200, 300. In certain implementations, each panel 100, 200, 300 can hold a plurality of tray elements 115 along a height H of the panel.

At each communications panel 100, 200, 300, one or more input cables IC are connected to two or more output cables OC so that data signals may pass therebetween. The input and output cables IC, OC are coupled together at the cassettes 120. It will be understood that the terms “input” and “output” are used for convenience and are not limiting to the direction of travel of the optical signals. Both types of cables may carry bi-directional data signals. In certain implementations, the tray elements 115 provide cable management for the input and/or output cables IC, OC routed to the cassettes 120. For example, the tray elements 115 may route the input cables IC towards a front of the panel 100, 200, 300 from a rear of the cassettes 120 as will be described more herein. It will be understood that only portions of the input and output cables IC, OC are shown throughout the drawings for ease in viewing.

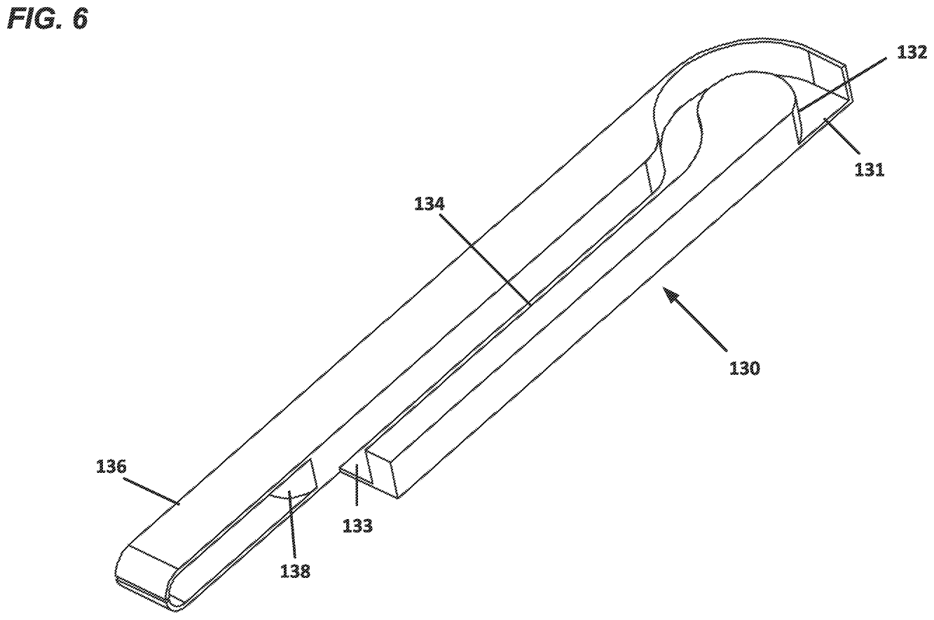

In certain implementations, each cassette 120 extends along a depth D2 between a front 122 and a rear 124 (e.g., see FIG. 6). Each cassette 120 is configured to receive one or more output cables OC or connectorized ends of one or more output cables OC at the front end 122. For example, each cassette 120 may carry one or more front port members 126 (e.g., optical adapters, electrical receptacles, hybrid ports, etc.) at the front 122 of the cassette 120 to receive connectorized ends of the output cables OC. In certain implementations, each cassette 120 is configured to receive one or more input cables IC or connectorized ends of one or more input cables IC at the rear 124 of the cassette 124. For example, some example cassettes 120 carry one or more rear port members 128 (e.g., optical adapters, electrical receptacles, hybrid ports, etc.) at the rear 124 of the cassette 120 to receive connectorized ends CE of the input cables IC. Other example cassettes 120 define a cable port at the rear 124 through which the input cable IC may enter a body of the cassette 120. In some such examples, one or more connectorized ends of the input cables IC plug into rear ports of the front port members 126. In other such examples, unterminated ends of the input cables IC may be spliced, split, or otherwise coupled to connectorized pigtails within the cassette 120 to connect the input cables IC to rear ports of the front port members 126. Examples of suitable cassettes are disclosed in U.S. Publication No. 2022/0260799 [attorney docket no. 02316.8221USU1], the disclosure of which is hereby incorporated herein by reference in its entirety.

In certain implementations, the cassettes 120 are installed at the panels 100, 200, 300 by mounting the cassettes 120 to the tray elements 115. In some implementations, a cassette 120 is mounted to the panels 100, 200, 300 as a unit with a corresponding tray element 115. In other implementations, the tray element 115 may be installed at the panel 100, 200, 300 and then the cassette 120 can be mounted to the tray element 115. In certain implementations, each tray element 115 includes a plurality of spaced apart guides 118 at which the cassette 120 can be releasably mounted.

In certain implementations, the communications panels 100, 200, 300 enable front-access of both the input and output cables IC, OC. For example, the input cables IC and output cables OC enter and exit, respectively, the communications panel 100 from the front 102, 202, 302 of the communications panel 100, 200, 300. Accordingly, the communications panels 100, 200, 300 are configured to route the input cables IC from the rear 124 of each cassette 120 to the front 102, 202, 302 of the panel 100, 200, 300.

In certain implementations, the input cables IC are routed to the communications panel 100, 200, 300 from one side 106, 206, 306, 108, 208, 308 of the panel 100, 200, 300 while the output cables OC are routed from the communications panel 100, 200, 300 from the opposite side 108, 208, 308, 106, 206, 306 of the panel 100, 200, 300. In certain implementations, the cassettes 120 or tray elements 115 (e.g., trays 116, cassette managers 230, 330, etc.) to which the cassettes 120 are mounted are releasably locked in a retracted position within the chassis 100, 200, 300. In certain implementations, the cassettes 120 and tray elements 115 are not lockable in an extended position relative to the chassis 100, 200, 300. In some examples, the cassettes 120 are installed on the tray elements 115 that are then mounted within the chassis 100, 200, 300 as units. In other examples, however, the tray elements 115 may be preinstalled within the panel 100 and the cassettes 120 can be thereafter mounted to the tray elements 115.

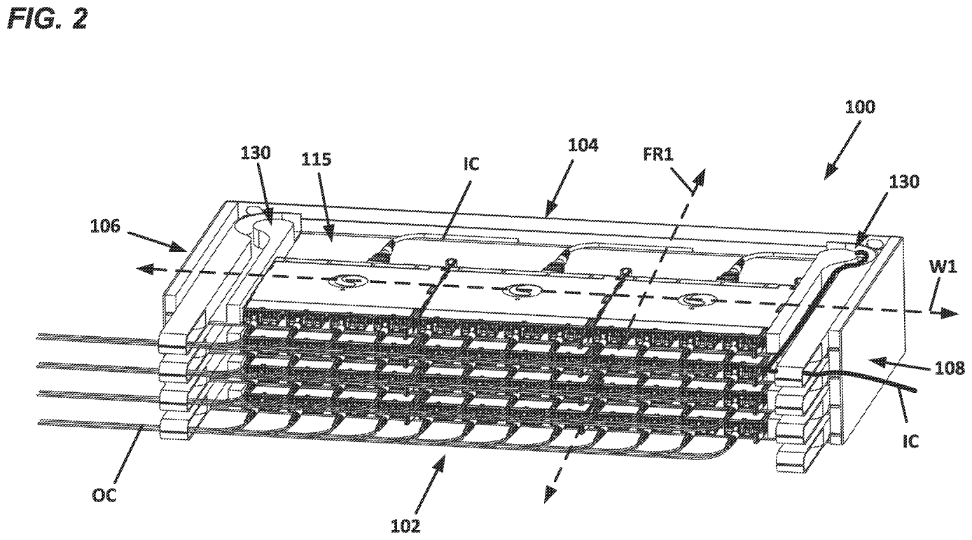

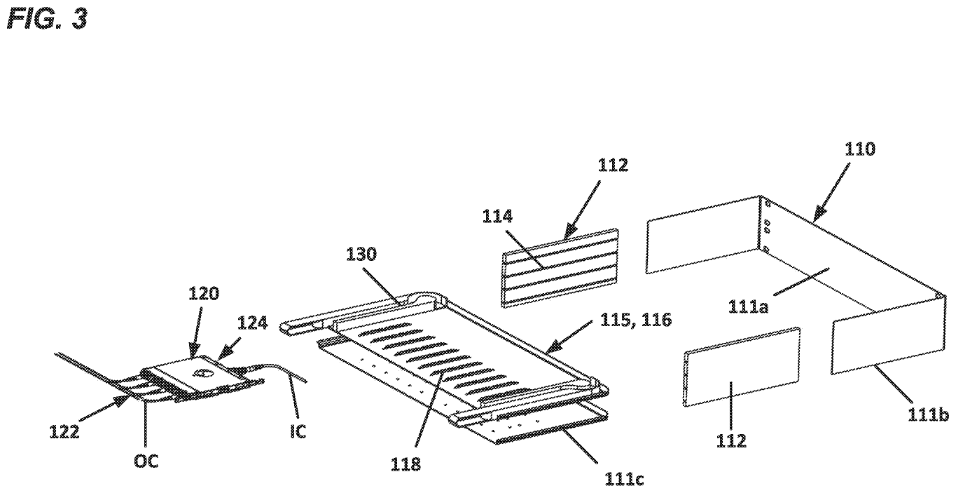

FIGS. 2-6 illustrate one example implementation of a communications panel 100 for which the cassettes 120 are mounted to one or more trays 116, each of which mounts within a chassis 110. In certain implementations, the chassis 110 includes side walls 111b extending forwardly from a rear wall 111a (see FIG. 3) to define an interior. In certain implementations, a bottom wall 111c also extends forwardly of the rear wall 111a and extends between the side walls 111b. In certain implementations, tray guides 112 can be mounted to the side walls 111b. Each tray guide 112 defines one or more slots 114 along which the tray elements 115 can be mounted to the chassis 110.

In certain implementations, a tray element 115 includes a tray 116 that spans the width W of the panel 100. In certain examples, multiple trays 116 can mount within a common chassis 110. In the example shown in FIG. 2, four trays 116 mount within the chassis 110. In other examples, a greater or lesser number of trays 116 (e.g., one tray, two trays, three trays, six trays, etc.) can fit within the chassis 110. In certain examples, the chassis 110 has a height of 1 rack unit (RU) space. In other examples, the chassis 110 can be taller (e.g., two RU, four RU, etc.).

Each tray 116 is configured to hold one or more cassettes 120 of various size (e.g., as discussed in U.S. Publication No. 2022/0260799 incorporated above). In certain implementations, each tray 116 carries one or more cassette guides 118 at which the cassettes 120 are secured to the tray 116. In certain examples, the cassette guides 118 extend in parallel along a forward-rearward axis FR1 of the panel 100. The cassette guides 118 are spaced from each other along with the width W1 of the panel 100. Each cassette guide 118 defines a stop region including a catch surface configured to engage a corresponding stop feature on the cassette 120 to hold the cassette 120 at a fixed position at the stop region of the cassette guide 118. Example cassette guides 118 are disclosed in U.S. Provisional Application No. 63/496,183, filed Apr. 14, 2023, [having attorney docket number 02316.8758USP1], the disclosure of which is hereby incorporated herein by reference in its entirety.

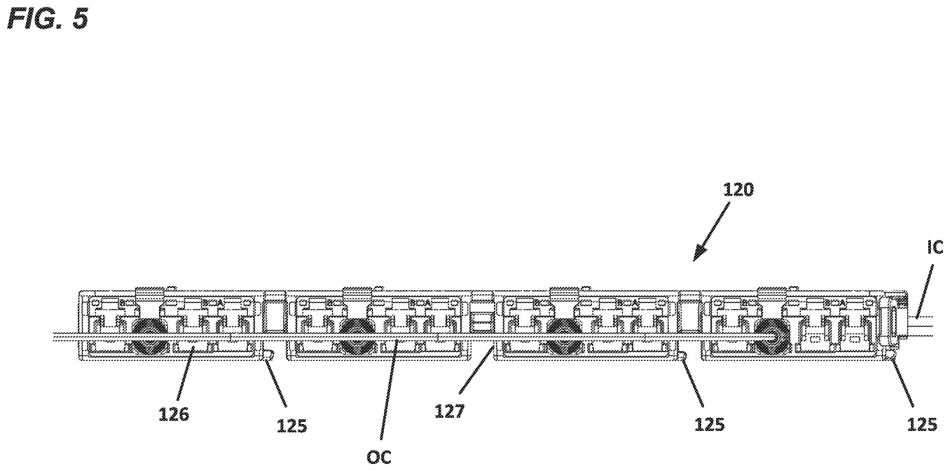

As shown in FIG. 5, each cassettes 120 include two or more rails 125 that engage the catch surface(s) of corresponding ones of the cassette guides 118. In certain implementations, at least one of the rails 125 is disposed within a corresponding bottom channel 127 defined along the cassette 120. In the example shown, two rails 125 are dispose within corresponding bottom channels 127. In certain implementations, one of the rails 125 extends outwardly from a side of the cassette 120. In certain implementations, no rail extends from the opposite side of the cassette 120.

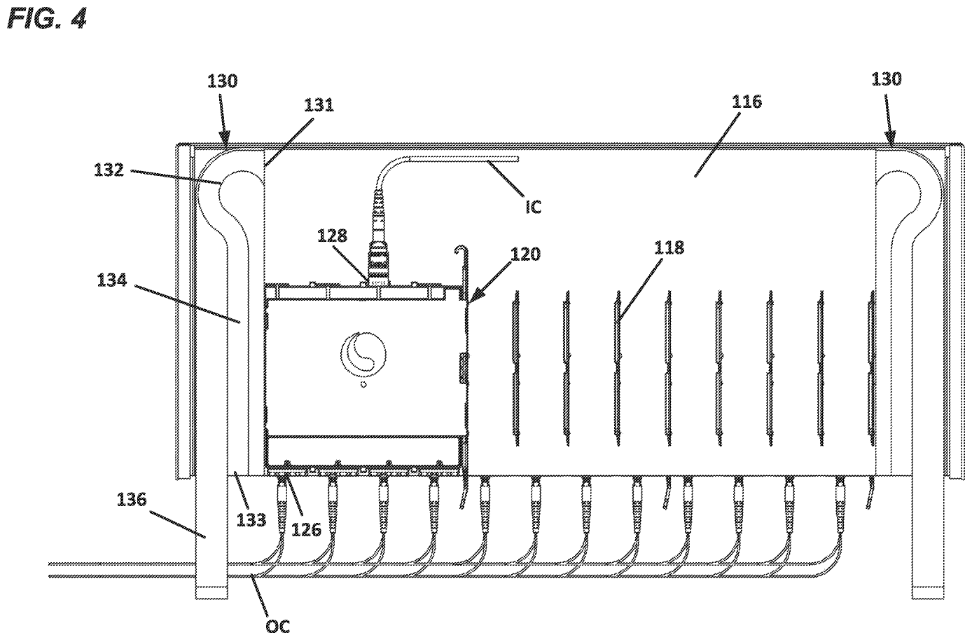

In the example shown in FIG. 2, each tray 116 is configured to hold a sufficient number of cassettes 120 to enough front port members 1126 to make at least 48 fiber connections (e.g., 48 LC ports, 96 SN ports, 24 MPO ports, etc.). In the example shown, the cassette 120 includes sufficient front port members 126 to make sixteen fiber connections at the cassette 120. The tray 116 shown in FIG. 4, is sized to hold three such cassettes 120. In other examples, however, each tray 116 is configured to hold a greater or lesser number of cassettes 120 and/or sufficient port members to make a greater or lesser number of connections (e.g., 24 fiber connections, 36 fiber connections, etc.). In certain examples, the frame R is at least a 19 inch rack. In certain examples, the frame R is larger than a 19 inch rack. For example, the frame R may be a 23 inch rack.

In accordance with aspects of the disclosure, both the input cables IC and the output cables OC are accessible at the front of the panel 100. In certain examples, the input cables IC are routed to the panel 100 from a first side 106 of the panel 100 and the output cables OC are routed away from the panel 100 from a second side 108 of the panel 100 (e.g., see FIG. 2). In certain implementations, one or more cable routing guides 130 are carried by the tray 116 to guide the input cables IC from the rear 124 of the cassettes 120 at the rear 104 of the panel 100 towards the front 102 of the panel 100. In certain examples, the cable routing guides 130 route the cables past the front 122 of the cassettes 120.

In certain implementations, a tray 116 carries a first cable routing guide 130 at a first side of the tray 116 and a second cable routing guide 130 at a second side of the tray 116. In certain examples, the first and second cable routing guides 130 are mirror images of each other. In certain examples, each cable routing guide 130 defines a path 134 extending between an entrance 131 at the rear of the tray 116 and an exit 133 at the front of the tray 116. In certain examples, each cable routing guide 130 includes a bend radius limiter 132 disposed along the path 134. In the example shown, the bend radius limiter 132 is disposed towards the entrance 131.

In certain implementations, the cable routing guide 130 includes a protruding guide member 136 at the front. In certain examples, the protruding guide member 136 extends forwardly of the tray 116 (e.g., see FIG. 2). In certain examples, the protruding guide member 136 extends forwardly of the panel 100. The protruding guide member 136 defines a cable passage extending parallel to the width W1 of the panel 100. In certain implementations, the protruding guide member 136 defines a bend radius limiter 138 facing into the cable passage to inhibit excess bending of cables IC, OC routed through the protruding guide member 136.

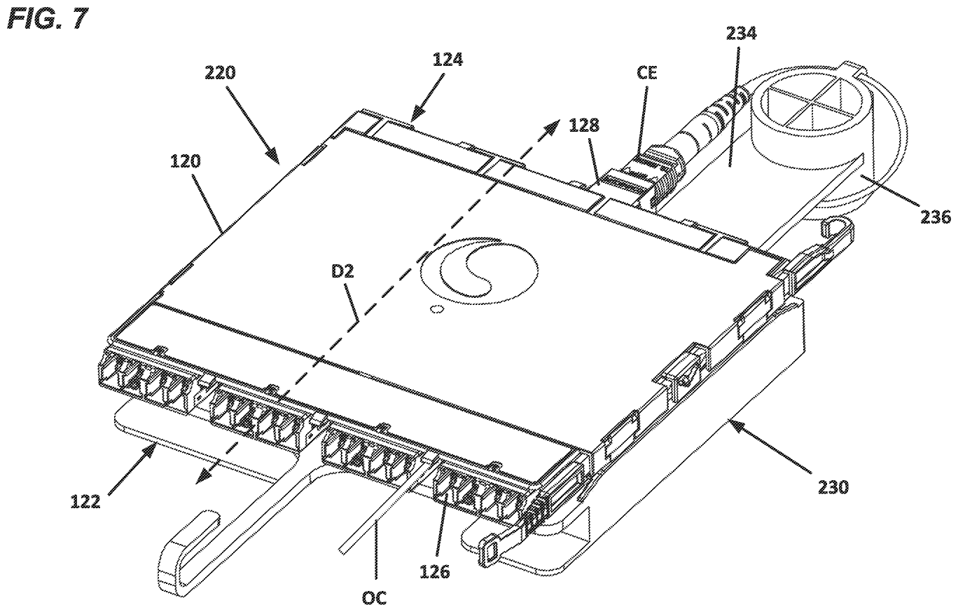

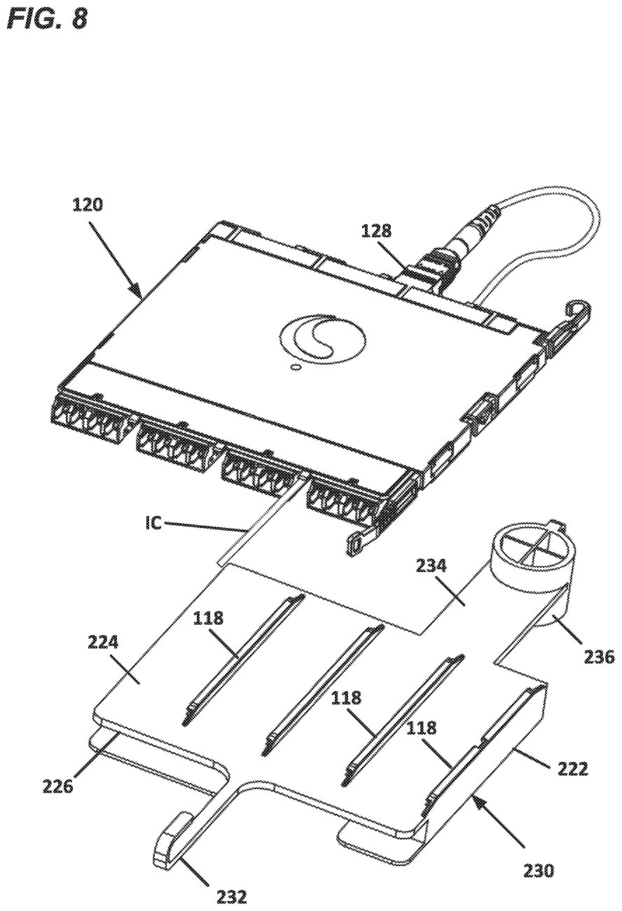

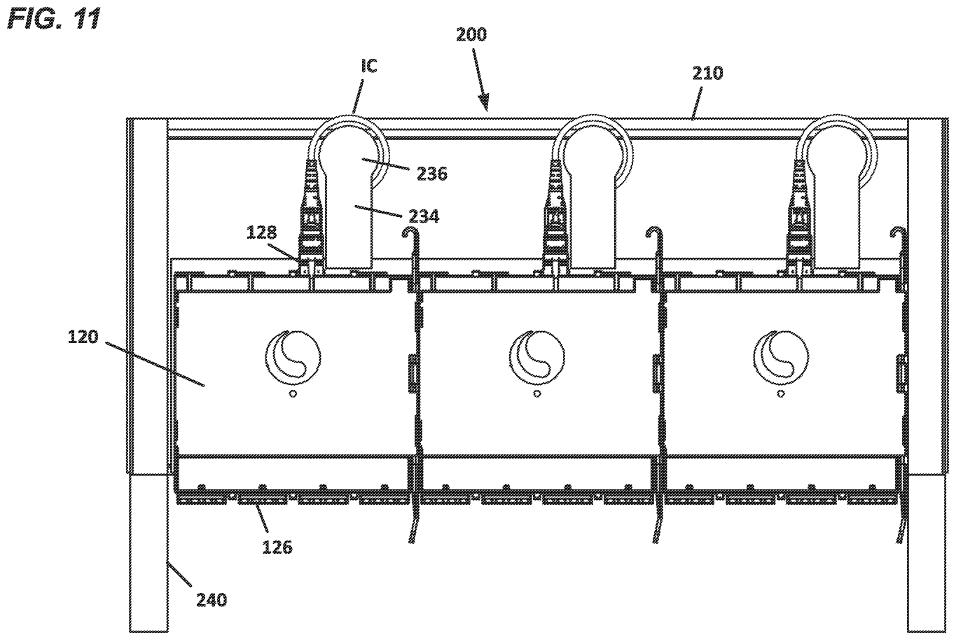

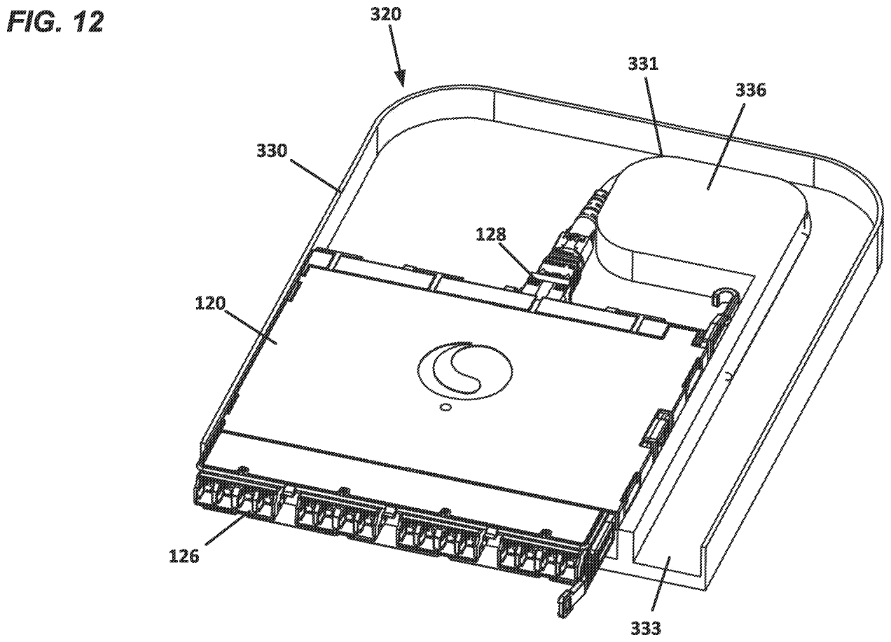

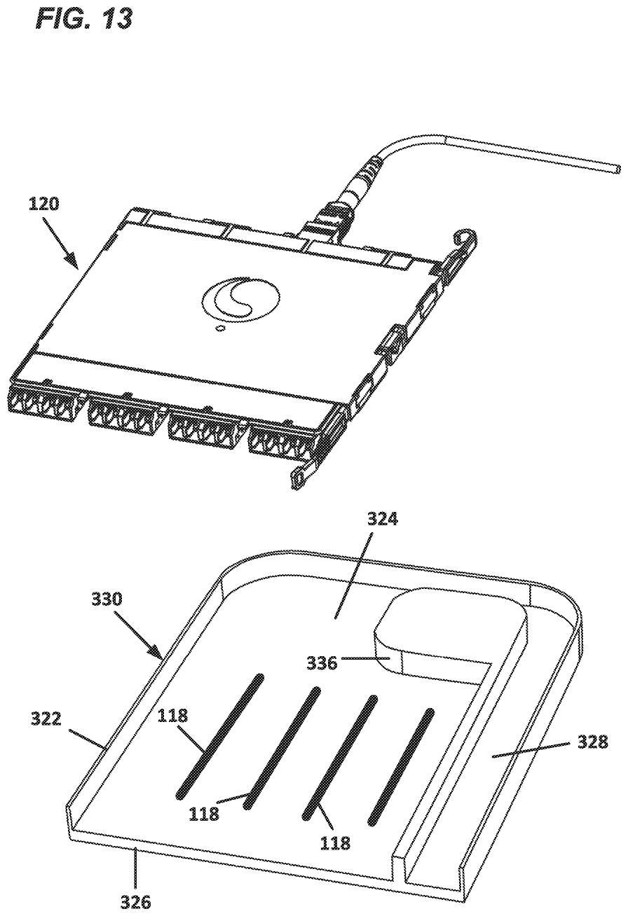

FIGS. 7-11 and 12-15 illustrate other example implementations of a communications panel 200, 300 for which the cassettes 120 are mounted to respective cassette managers 230, 330, each of which mounts within a chassis 210, 310. In some examples, each cassette 120 is mounted to its own unique cassette manager 230, 330 (e.g., see FIGS. 7 and 12). In other examples, however, one cassette manager 230, 330 may hold two or more cassettes 120. The cassette 120 releasably locks (e.g., latches) to the corresponding cassette manager 230, 330 so that the cassette 120 and the cassette manager 230, 330 can be moved together as a unit 220, 320 (e.g., see FIGS. 7 and 12).

Referring to FIGS. 7-11, the cassette manager 230 includes a body 222 having a first side 224 and an opposite second side 226. The cassette manager 232 also includes a forward handle 232 by which the cassette manager 230 (or the cassette manager 230 with mounted cassette 120) can be manipulated (e.g., pulled and/or pushed). The cassette 120 is configured to mount to the first side 224 and the input cable IC of the cassette 120 is configured to route along the second side 226 of the cassette manager 230 to the front of the cassette 120. A cable guide path 228 is defined at the second side 226 of the cassette manager 230.

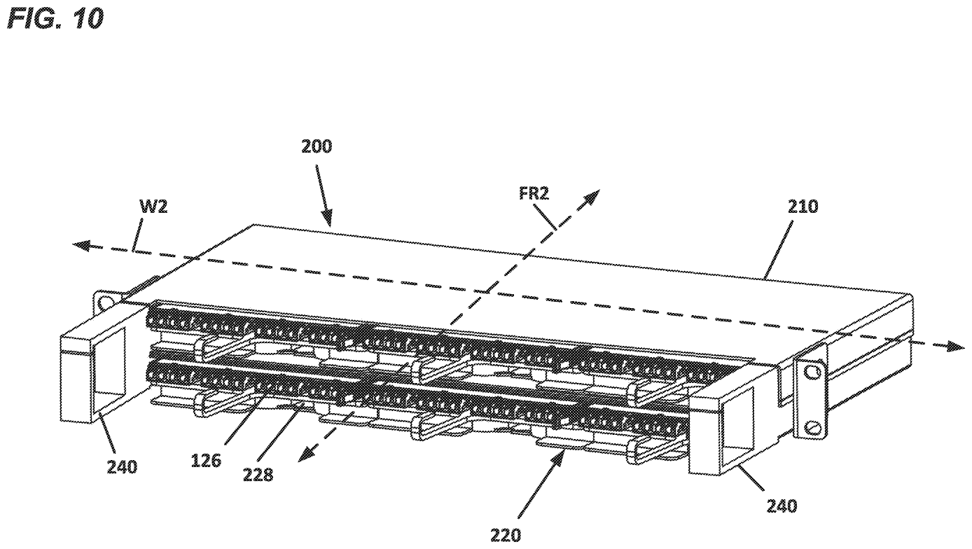

One or more cassette guides 118 are disposed at the first side 224 of the cassette manager 230. In certain examples, the cassette guides 118 extend in parallel along a forward-rearward axis FR2 of the panel 200 (e.g., FIG. 10). The cassette guides 118 are spaced from each other along with the width W2 of the panel 200. Each cassette guide 118 defines a stop region including a catch surface configured to engage a corresponding stop feature on the cassette 120 to hold the cassette 120 at a fixed position at the stop region of the cassette guide 118. Example cassette guides 118 are disclosed in U.S. Provisional Application No. 63/496,183 incorporated by reference above.

In certain implementations, a bend radius limiter 236 is disposed at the rear of the cassette manager 230 to enable routing of the input cable IC from the rear of the cassette 120 to the cable guide path 228. In certain implementations, the bend radius limiter 236 is disposed at a rear extension 234 of the cassette manager 230 that aligns with the rear port member 128 or rear cable port of the cassette 120 when the cassette 120 is mounted to the cassette manager 230. In certain examples, the rear extension 234 assists in supporting a rear connector of the input cable IC plugged into the rear port member 128 and/or the input cable IC extending out of the rear cable port.

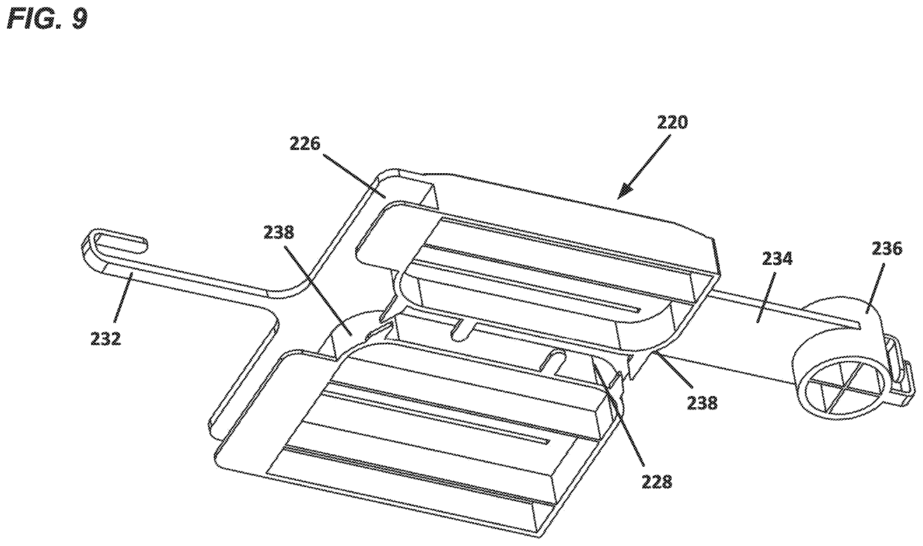

As shown in FIG. 9, one or more bend radius limiters 238 also are disposed at the second side 224 of the cassette manager 230 to define the cable guide path 228. In certain implementations, two opposing bend radius limiters 238 define the cable guide path 228 therebetween. In certain implementations, the cable guide path 228 is aligned with one side of the bend radius limiter 236 to guide the input cable IC from the bend radius limiter 236 into the cable guide path 228. In certain implementations, the other side of the bend radius limiter 236 aligns with the rear port member 128 or rear cable port of the cassette 120 (e.g., see FIG. 7).

As shown in FIG. 10, two or more cassette units 220 of the cassette manager 230 and the cassettes 120 can be disposed at a chassis 210 to form the communications panel 200. In the example shown, the cassette units 220 mount in a horizontal orientation within the chassis 210. In some examples the cassettes 120 and cassette managers 230 are mounted at the chassis 210 as units 220. In other examples, the cassette managers 230 can be mounted to the chassis 210 first and the cassettes 120 can be subsequently mounted to the cassette managers 230. In certain implementations, the cassette units 220 are disposed in two or more rows. In certain implementations, multiple cassette units 220 can be disposed in each row. In certain implementations, the cassette units 220 form alternating rows of front port members 126 and cable guide paths 228 (e.g., see FIG. 10).

In some implementations, the chassis 210 includes one or more trays to which the cassette units 220 can mount. In other implementations, the chassis 210 may include intermediate walls to which the cassette units 220 can mount. In certain implementations, the cassette 120 is secured to the cassette manager 230 and the cassette manager 230 is secured to the tray or intermediate walls. In certain implementations, the cassette units 220 (e.g., the cassette managers 230) are secured to the chassis 210 in fixed positions. In certain implementations, the cassette units 220 (e.g., the cassette managers 230) are securable to the chassis 210 in only one fixed position. In various examples, the cassette units 220 (e.g., the cassette managers 230) are latched to the chassis 210.

In certain implementations, one or more protruding guide members 240 extend forwardly of the chassis 210. In the example shown, protruding guide members 240 are disposed at opposite sides of the chassis 210. The input cables IC extending out of the cable guide paths 228 can be routed in front of the panel 200 towards one of the protruding guide members 240 while the output cables OC received at the front port members 126 can be routed in front of the panel 200 towards the other of the protruding guide members 240.

Referring to FIGS. 12-15, the cassette manager 330 includes a body 322 having a first side 324 and an opposite second side 326. In certain examples, the cassette manager 330 also includes a forward handle by which the cassette manager 330 (or the cassette manager 330 with mounted cassette 120) can be manipulated (e.g., pulled and/or pushed). In certain examples, the cassette 120 is configured to mount to the first side 324 of the cassette manager 330. In certain examples, the input cable IC of the cassette 120 also is configured to route along a cable guide path 328 defined at the first side 324 of the cassette manager 330. In certain examples, the cable guide path 328 extends from an entrance 331 at the rear of the cassette manager 330 and an exit 333 at the front of the cassette manager 330.

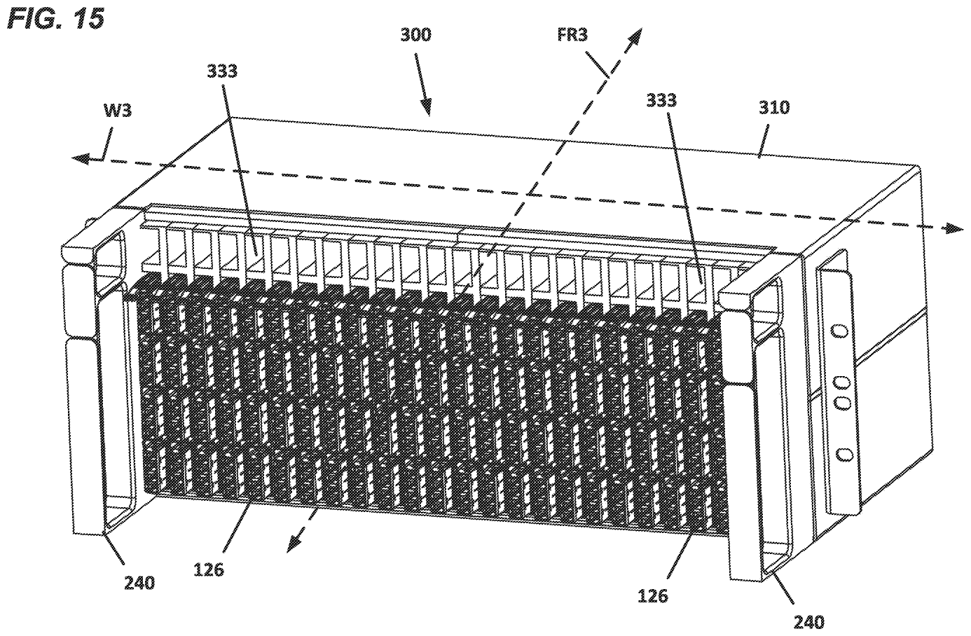

One or more cassette guides 118 are disposed at the first side 324 of the cassette manager 330. In certain examples, the cassette guides 118 extend in parallel along a forward-rearward axis FR3 of the panel 300 (e.g., FIG. 15). The cassette guides 118 are spaced from each other along with the width W3 of the panel 300. Each cassette guide 118 defines a stop region including a catch surface configured to engage a corresponding stop feature on the cassette 120 to hold the cassette 120 at a fixed position at the stop region of the cassette guide 118. Example cassette guides 118 are disclosed in U.S. Provisional Application No. 63/496,183 incorporated by reference above.

In certain implementations, a bend radius limiter 336 is disposed at the rear of the cassette manager 330 to enable routing of the input cable IC from the rear of the cassette 120 to the cable guide path 328. In certain implementations, the bend radius limiter 336 is disposed within a footprint of the cassette manager 330. In certain implementations, the bend radius limiter 336 seats on or extends upwardly from the first side 324 of the cassette manager 330. In an example, the bend radius limiter 336 is integrally formed with the body 322 of the cassette manager 330. In certain examples, one side of the bend radius limiter 336 aligns with the rear port member 128 or rear cable port of the cassette 120 when the cassette 120 is mounted to the cassette manager 330. In certain examples, the opposite side of the bend radius limiter 336 bounds and/or defines the cable guide path 328.

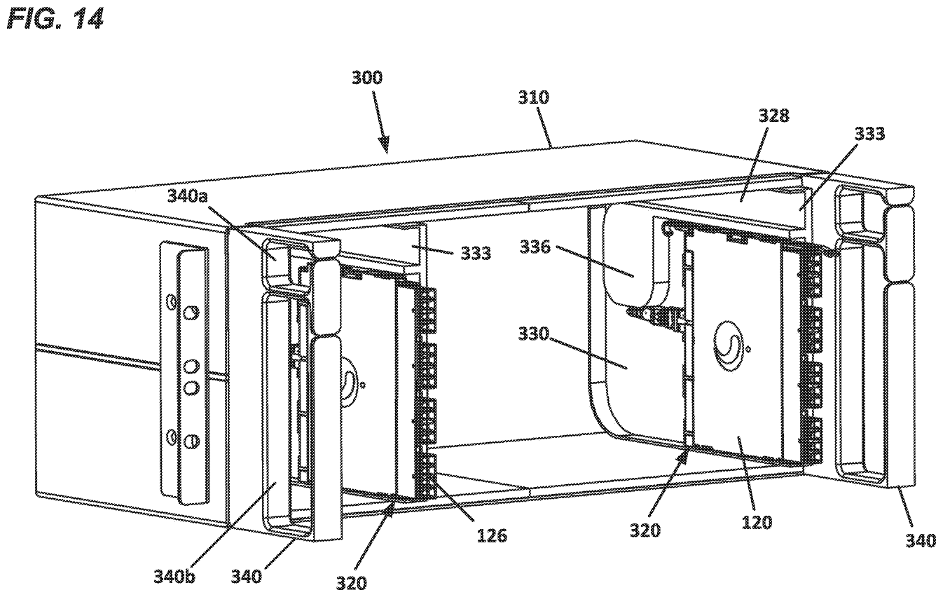

As shown in FIGS. 14 and 15, two or more cassette units 320 can be disposed at a chassis 310 to form the communications panel 300. In certain implementations, the cassette units 320 can be mounted in a vertical orientation within the chassis 310. In some examples the cassettes 120 and cassette managers 330 are mounted at the chassis 310 as units 320. In other examples, the cassette managers 330 can be mounted to the chassis 310 first and the cassettes 120 can be subsequently mounted to the cassette managers 330. In certain implementations, the cassette units 320 are disposed in a row. In certain examples, the cassette units 320 can be disposed in a plurality of rows.

In certain implementations, the cassette units 320 are configured to latch or otherwise secure to the chassis 310. In certain examples, the cassette units 320 or cassette managers 330 are slidingly mountable to the chassis 310. In certain implementations, the cassette 120 is secured to the cassette manager 330 and the cassette manager 330 is secured to a top or bottom wall of the chassis 310. In certain implementations, the cassette units 320 (e.g., the cassette managers 330) are secured to the chassis 310 in fixed positions. In certain implementations, the cassette units 320 (e.g., the cassette managers 330) are securable to the chassis 310 in only one fixed position.

In certain implementations, one or more protruding guide members 340 extend forwardly of the chassis 310. In the example shown, protruding guide members 340 are disposed at opposite sides of the chassis 310. The input cables IC extending out of the exits 333 of the cable guide paths 328 can be routed in front of the panel 300 towards one side of the panel 300 while the output cables OC received at the front port members 126 can be routed in front of the panel 300 towards the other side of the panel 300. In certain implementations, the cassette units 320 form alternating rows of cable guide path exits 333 and front port members 126 (e.g., see FIG. 15). In some such implementations, the protruding guide members 340 each define a first cable path 340a aligned with the row of cable guide path exits 333 and a second cable path 340b aligned with the front port members 126 of the cassettes 120.

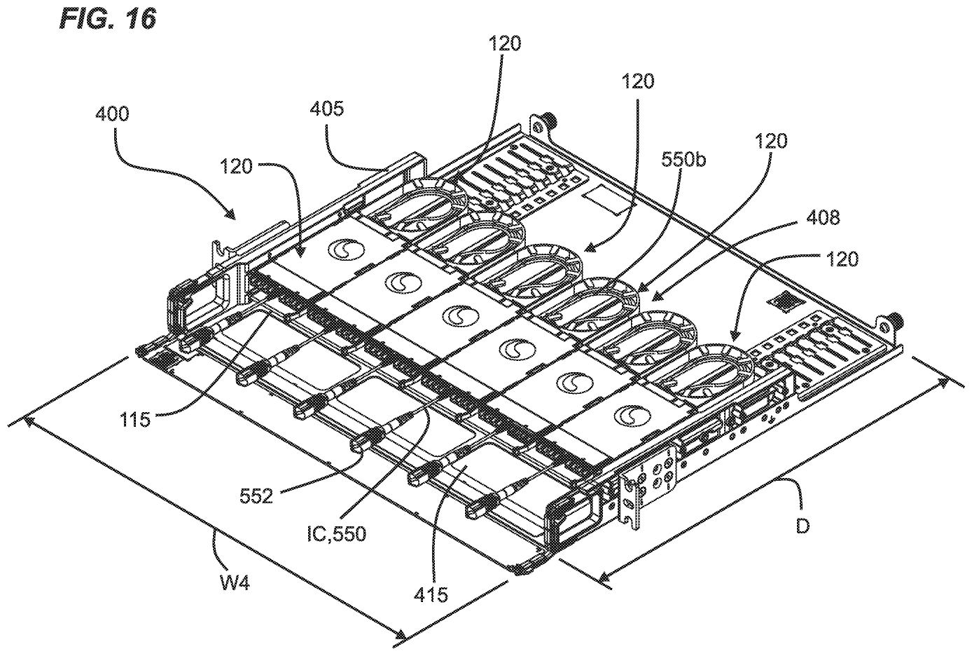

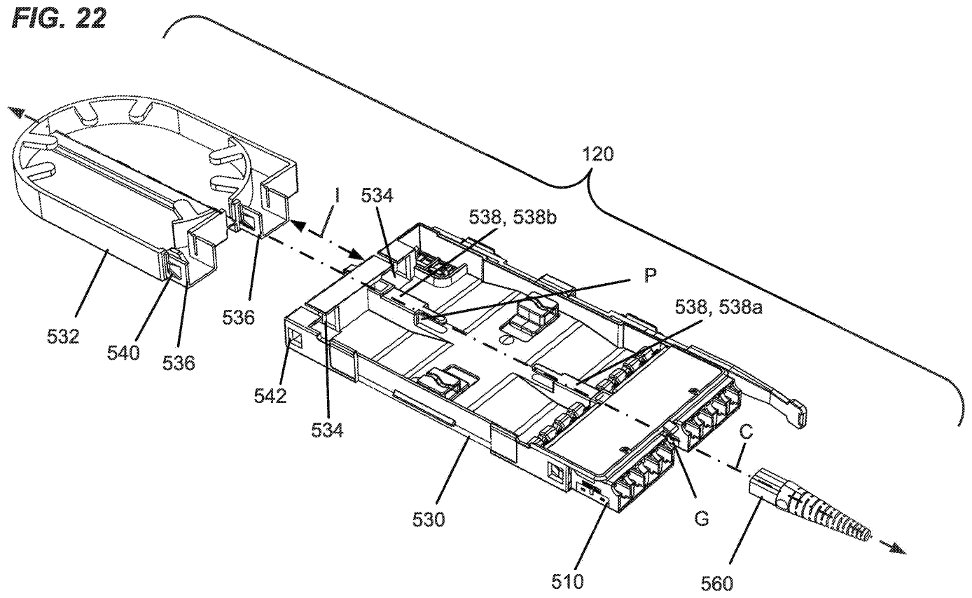

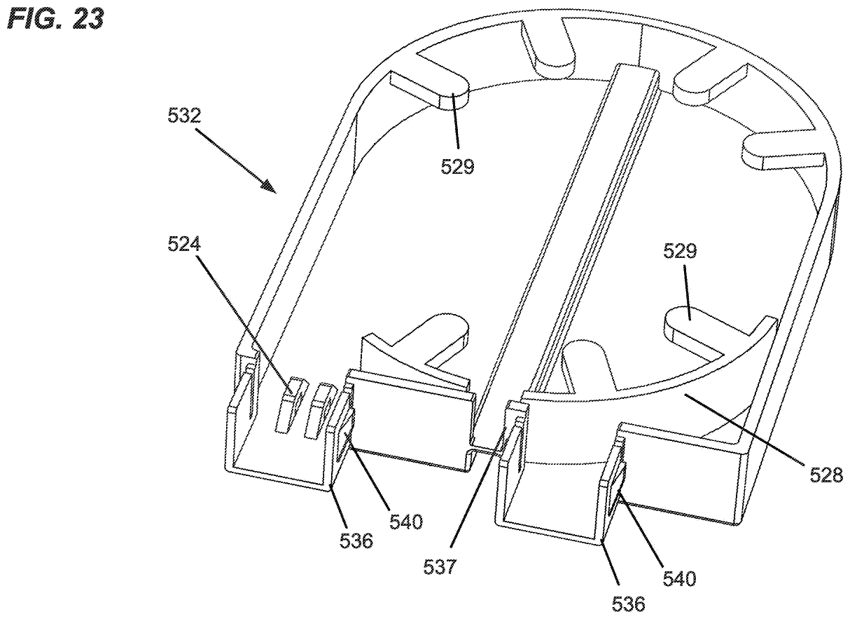

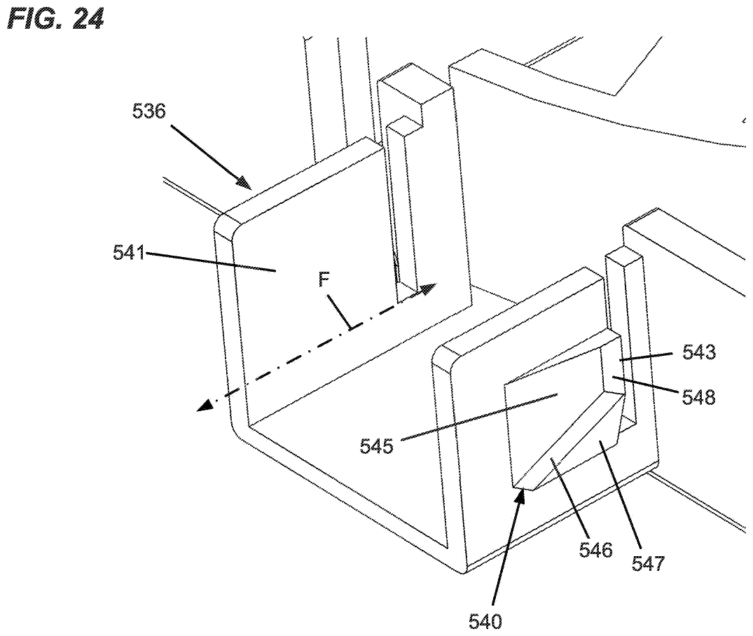

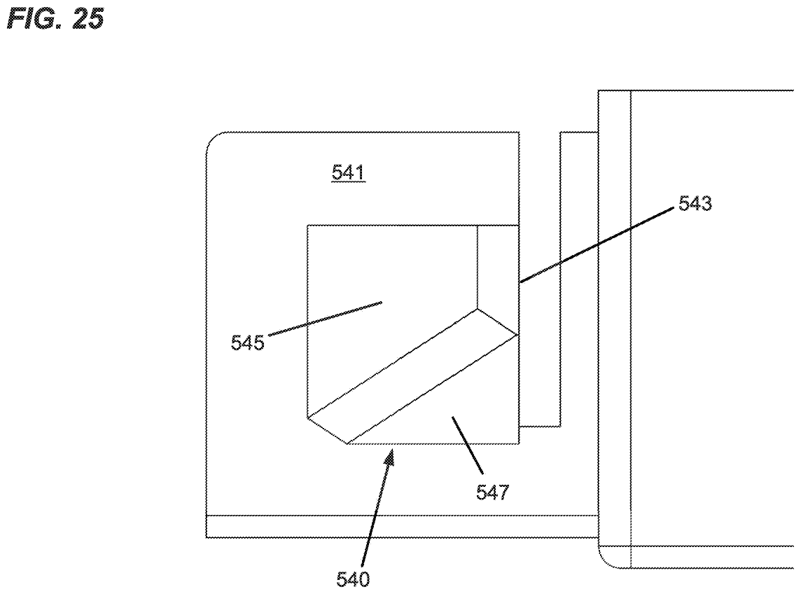

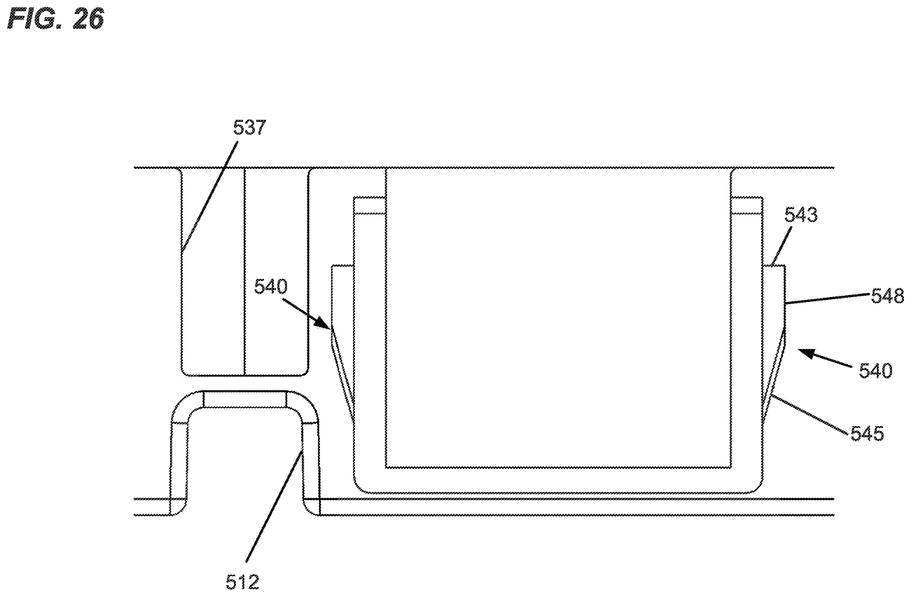

Referring now to FIGS. 16-26, another example communications panel 400 includes a chassis 405 holding one or more tray elements 115. The chassis 405 is configured to mount to the rack R. Each tray element 115 is a tray that spans a width W of the chassis 405. In some implementations, the tray elements 115 are stationary within the chassis 405. In other implementations, the tray elements 115 are slidable along a depth D of the chassis 405 between two or more positions. Each tray element 115 is configured to support one or more cassettes 120 carrying ports (e.g., optical ports, electrical ports, hybrid ports, etc.) configured to receive plug connectors. In the example shown, the tray element 115 is a tray configured to receive a plurality of cassettes 120. A tray element 115 populated with one or more cassettes 120 is referred to herein as a communications arrangement 408.

As will be discussed in more detail herein, a cassette 120 carries one or more port members 510 each defining one or more exteriorly accessible ports (i.e., front ports) at a front of the cassette 120. The exterior ports are configured to receive plug connectors. In some implementations, the exterior ports are optical ports configured to receive optical plug connectors. In other implementations, the exterior ports may be electrical ports configured to receive electrical plug connectors, hybrid ports configured to receive hybrid plug connectors, or a mixture of optical, electrical, and/or hybrid. In some implementations, a cassette 120 carries single-fiber exterior ports (e.g., LC front ports). In other implementations, a cassette 120 carries multi-fiber exterior ports (e.g., MPO front ports, SN front ports offered by Senko, etc.). In still other implementations, the same cassette 120 may carry a mix of two or more types of exterior ports (e.g., a mixture of MPO and LC ports).

In some implementations, the cassette 120 carries a cable 550 (e.g., a fiber cable, an electrical cable, a hybrid cable, etc.) that functions as the input cable IC. The cable 550 carries signals between the exterior ports 510 and a connectorized end 552. In some examples, the cable 550 extends between the connectorized end 552 at a first end of the cable 550 and one or more connectorized ends 554 at an opposite second end of the cable 550. The connectorized end(s) 554 are received at the port members 510 (e.g., at interior/rear ports of the port members 510) that are in communication with the exterior ports. In other examples, the cable 550 extends to one or more unconnectorized second ends that are coupled to the port members 510 (e.g., unterminated electrical wires that are mounted to insulation displacement contacts of the port member 510).

The connectorized end 552 of the cable 550 is accessible from an exterior of the cassette 120. In certain implementations, the connectorized end 552 is accessible from the front of the tray element 115 when the cassette 120 is mounted at the tray element 115. In certain examples, the cable 550 extends outwardly through a front of the cassette 120 past the exterior ports of the port members 510 so that the connectorized end 552 is disposed in front of the cassette 120.

In certain implementations, a strain relief member 560 is mounted at the front of the cassette 120. The strain relief member 560 is configured to be axially stationary relative to the cassette 120. The strain relief member 560 is configured to flex or deform along a width and/or height of the cassette 120 to provide strain relief to the cable 550 as the cable 550 extends outwardly through the front of the cassette 120. In certain examples, the strain relief member 560 tapers radially inwardly as the strain relief member 560 extends away from the cassette 120. In certain implementations, the cable 550 is axially slidable through the strain relief member 560 relative to the cassette 120.

In certain implementations, the connectorized end 552 of the cable 550 also includes a strain relief member 558. The strain relief member provides strain relief to the cable 550 at the terminated end 552. In certain examples, the strain relief member 558 faces in an opposite orientation to the strain relief member 560. In certain implementations, the strain relief member 558 tapers radially inwardly as the strain relief member 558 extends away from the connectorized end 552 and towards the cassette 120. In certain implementations, a length of cable 550 between the strain relief members 558, 560 increases as the cable 550 is paid out from the cassette 120.

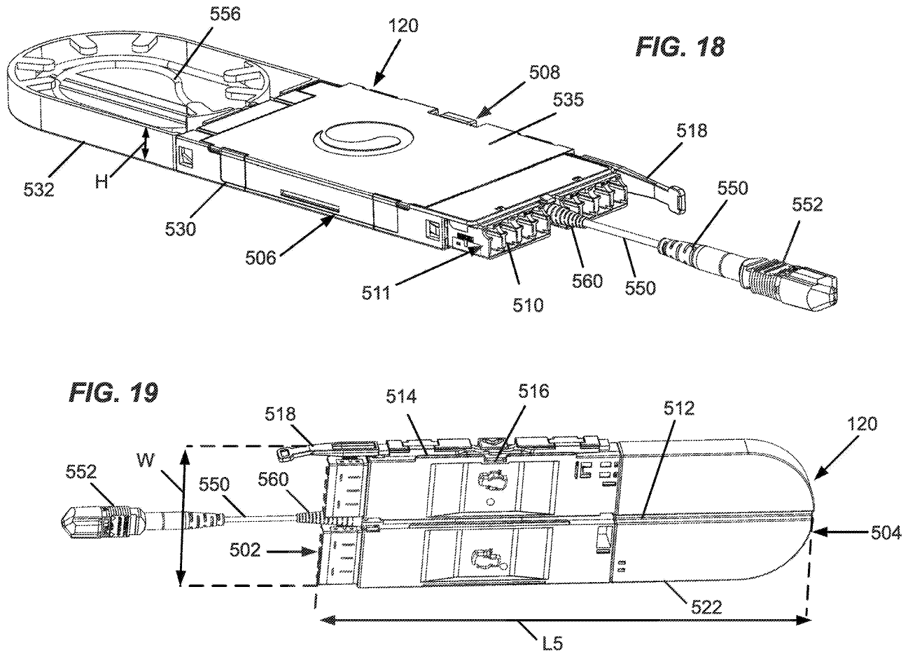

In certain implementations, the cable 550 includes an intermediate section 550b stowed within the cassette 120 (e.g., see FIG. 18). In certain implementations, at least a portion of the cable 550 (e.g., at least some of the intermediate section 550b) can be paid out from the interior of the cassette 120 to increase the amount of cable 550 disposed outside of the cassette 120. In certain examples, the intermediate section 550b is stowed at a rear of the cassette 120 before being paid out from the cassette 120. In some examples, the intermediate section 550b is freely coiled in a storage region of the cassette 120. In other examples, the intermediate section 550b is guided in a looped or figure-8 configuration by cable guide members.

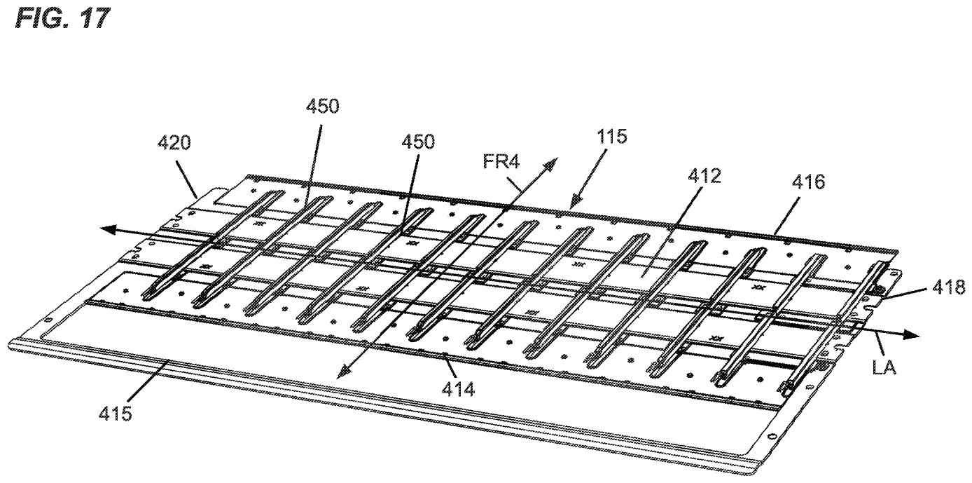

In certain implementations, the cassettes 120 are slidably mounted to the tray element 115 along guides 450. In certain examples, each cassette 120 is independently slidable relative to the other cassettes 120. In the example shown in FIG. 17, the tray element 115 includes a main region 412 that extends along a forward-rearward axis FR between a front end 414 and a rear end 416 of the main region 412. The main region 412 also extends along a lateral axis LA between opposite first and second ends 418, 420 of the main region 412. The main region 412 of the tray element 115 carries the guides 450. Each guide 450 extends parallel to the forward-rearward axis FR. The guides 450 are spaced from each other along the lateral axis LA. In certain implementations, the guides 450 are configured to slidingly receive a plurality of cassettes 120 along the guides 450 from either the front end 414 of the main region 412 or from the rear end 416 of the main region 412 at a discretion of a user.

In certain implementations, the tray element 115 defines a finger access aperture 415. In some examples, the finger access aperture 415 is defined through a main region 412 of the tray element 115. In other examples, the finger access aperture 415 is defined between a front of the main region 412 and a management rail disposed in front of the main region 412. In certain implementations, the cables 550 extend over the finger access aperture 415 between the cassettes 120 and the connectorized ends 552.

In certain implementations, each cassette 120 defines one or more bottom channels 512 along which respective guides 450 glides when the cassette 120 is being slid onto the tray element 115 (e.g., see FIG. 19). In certain implementations, each cassette 120 includes a guide rail 514 that glides along a respective one of the guides 450 when the cassette 120 is being slid onto the tray element 115. In certain implementations, each cassette 120 includes a stop member 516 that engages part of the respective guide 450 to lock the cassette 120 in position on the tray element 115. In certain implementations, each cassette 120 includes a release member 518 configured to disengage the stop member 516 from the guide 450. For example, the release member 518 can include a pull bar configured to move along the forward-rearward axis to transition the stop member between locking and releasing positions. Further details of an example stop member 516, release member 518, and guide 450 suitable for use with the cassette 120 and tray element 115 are disclosed in WO 5022/478310, the disclosure of which is hereby incorporated herein by reference in its entirety.

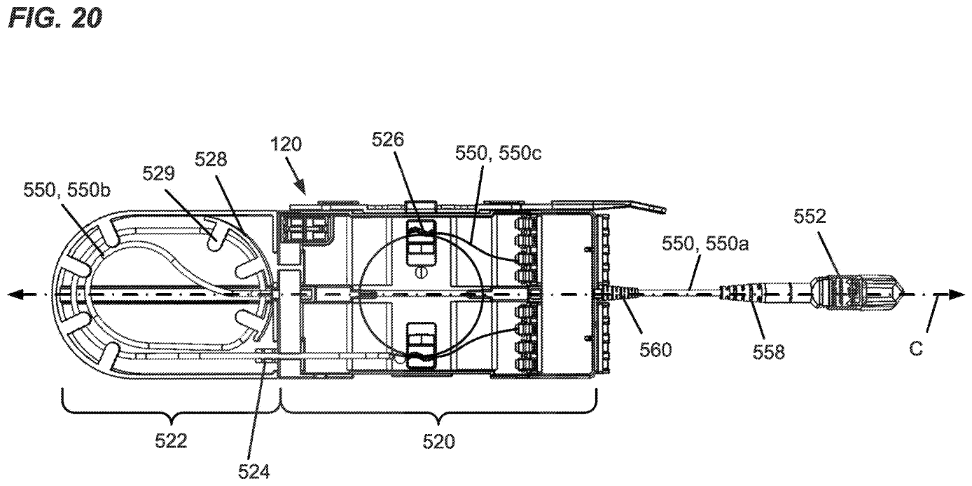

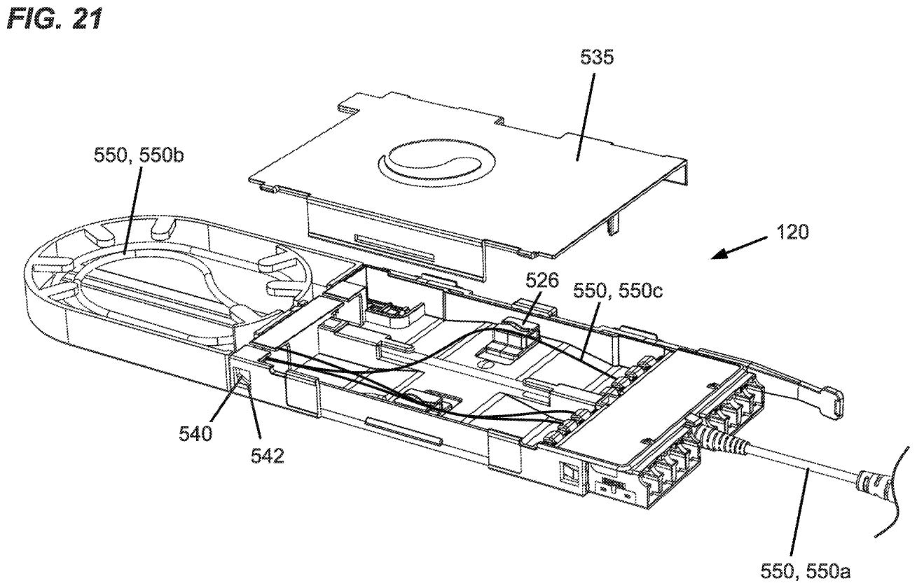

FIGS. 18-21 illustrate an example cassette 120 suitable for use in the communications panel 400 disclosed above. The cassette 120 extends along a length L between a front 502 and a rear 504, along a width W between opposite first and second sides 506, 508, and along a height H between a top and a bottom. The cassette 120 includes the front ports 510 at the front 502 of the cassette 120. A first portion 550a of the cable 550 extends forwardly of the front 502 of the cassette 120. A second portion 550b of the cable 550 is stowed towards the rear 504 of the cassette 120. A third portion 550c of the cable 550 is received at interior ports of the port members 510 (e.g., see FIG. 20).

In certain implementations, the cassette 120 defines a first region 520 and a second region 522. In certain examples, the first region 520 defines the front 502 of the cassette 120 and the second region 522 is disposed rearward of the first region 520. In certain examples, the second region 522 defines the rear 504 of the cassette 120 and the first region 520 is disposed forward of the second region 522. In certain examples, the first region 520 is enclosed. In certain examples, the second region 522 is open at the top to provide access to an interior of the second region 522. In certain examples, a majority of the excess length 520b of the cable 550 is stowed in the second region 522.

In certain implementations, a cable anchor station 524 is disposed within the cassette 120 to axially fix a portion of the cable 550 relative to the cassette 120. The cable anchor station 524 inhibits the second end 554 of the cable 550 from pulling out of the interior ports or from otherwise separating from the port members 510. In some implementations, the cable anchor station 524 is disposed at the second region 522 of the cassette 120. In other implementations, the cable anchor station 524 can be disposed within the first region 520 of the cassette 120. In certain examples, the cable anchor station 524 is disposed where the first and second regions 520, 522 meet. In some implementations, the cable anchor station 524 provides a mount for a cable tie or other wrap-style cable fastener. In other implementations, the cable anchor station 524 is configured to clamp or otherwise grip the cable 550.

The cable 550 includes one or more media segments disposed within a sheath, such as a cable jacket, tube, mesh sleeve, etc. As the term is used herein, a media segment refers to a fiber, wire, or such that carries signals and/or power. For example, an optical fiber and an electrical wire are each examples of a media segment. In certain examples, each of the media segments of the cable 550 are terminated at a connector (e.g., a plug connector, a female connector, etc.) defining the connectorized end 552. In certain examples, the media segments of the cable 550 are broken out (e.g., transitioned out of the sheath and separated from each other) between the first and second ends 552, 554 of the cable 550. For example, each media segment of the cable 550 may be separately terminated by a connector (e.g., a plug connector, a female connector, etc.) that can be received at the port members 510. In certain examples, the media segments are broken out at a fan-out device. In some examples, the fan-out device is mounted within the first region 520 of the cassette 120. In other examples, the fan-out device is mounted within the second region 522 of the cassette 120. In still other examples, the media segments are separated out without a fan-out device.

In certain implementations, the first region 520 of the cassette 120 includes one or more media segment managers 526. In certain examples, the media segment managers 526 include spools or bend radius limiters. In certain examples, the media segment managers 526 define guide channels at which media segments are collected and guided. Example media segment managers 526 suitable for use with the cassette 120 are disclosed in U.S. Publication No. 5022-0560799, the disclosure of which is hereby incorporated herein by reference in its entirety.

In certain implementations, the second region 522 of the cassette 120 includes one or more guides 528 that direct the second portion 550b of the cable 550 in a stowed arrangement (e.g., a coil, a figure-8 layout, etc.). In certain examples, the one or more guides 528 define contoured surfaces along which the cable 550 (e.g., the second portion 550b of the cable 550) extends. In some examples, the guides 528 have convexly contoured surfaces about which the cable 550 can be wound. In other examples, the guides 528 has concavely contoured surfaces within which the cable 550 can be contained (e.g., see FIGS. 20 and 21). One or more tabs 529 may extend outwardly or inwardly from the guides 528 to aid in retaining the cable 550 within the cassette 120.

In certain implementations, the cable 550 extends along a central longitudinal axis C of the cassette 120 as the cable 550 extends from the second region 522 to the front 502 of the cassette 120 (e.g., see FIG. 20). In certain examples, the cable 550 extends in alignment with the bottom channel 512 along the first region 520, but exterior from the bottom channel 512. For example, a floor of the cassette 120 is disposed between the cable 550 and the bottom channel 512.

In certain implementations, the first region 520 of the cassette 120 is defined by a first cassette piece 530 and the second region 522 of the cassette 120 is defined by a second cassette piece 532 that is removably connected to the first cassette piece 530. In certain implementations, the strain relief member 560 is mounted to the front of the first cassette piece 530. In certain implementations, the port members 510 are mounted to the first cassette piece 530. In certain examples, the strain relief member 560 is mounted at a gap G between adjacent port members 510.

In certain implementations, the first cassette piece 530 defines a central passage P extending along the longitudinal axis C of the cassette 120. In certain examples, the first cassette piece 530 includes guide members 538 that define the passage P. In the example shown, the first cassette piece 530 includes first and second guide members 538a, 538b spaced apart along the depth of the first cassette piece 530 and aligned with each other along the central longitudinal axis C. In certain implementations, the guides members 538 align with an aperture 537 defined by the second cassette piece 532 to enable the cable 550 to transition between the first and second cassette pieces 530, 532.

In certain implementations, the first and second cassette pieces 530, 532 define open tops through which interiors of the cassette pieces 530, 532 are accessible. In certain implementations, a cover 535 mounts to the first cassette piece 530 to block access to the interior of the first cassette piece 530. The cover 535 protects exposed media segments broken out from the sheath of the cable 550. In certain implementations, the second cassette piece 532 remains open during use so that at least part of the stowed portion 550b of the cable 550 is exposed through the open top of the second cassette piece 532 (e.g., see FIG. 16).

In certain implementations, the first and second cassette pieces 530, 532 are moved towards each other along an insertion axis I. In certain examples, the first and second cassette pieces 530, 532 are coupled together by inserting one or more protrusions 536 of one of the first and second cassette pieces 530, 532 into one or more apertures 534 defined by the other of the first and second cassette pieces 530, 532. In the example shown, the second cassette piece 532 includes the protrusion(s) 536 and the first cassette piece 530 defines the aperture(s) 534. In certain implementations, the aperture(s) 534 are disposed at a rear of the first cassette piece 530 and the protrusion(s) 536 are disposed at the front of the second cassette piece 532. In certain implementations, the first cassette piece 530 defines a plurality of apertures 534 and the second cassette piece 532 includes a plurality of protrusions 536.

In certain implementations, the first and second cassette pieces 530, 532 latch together. For example, the protrusion(s) 536 of one of the cassette pieces 530, 532 may include a deflectable tab 541 carrying or defining a latch 540. In certain examples, the deflectable tab 541 deflects or pivots along a flex axis F to move the latch 540 between latching and releasing positions. In certain implementations, the latch 540 engages a catch surface 542 when in the latching position and does not engage the catch surface 542 when in the releasing position. In certain examples, the flex axis F extends parallel with an insertion axis I.

In certain implementations, one or more of the latches 540 includes a ramped surface 545 leading to a stop surface 543. In certain examples, the stop surface 543 faces towards the cassette piece 530, 532 carrying the latch 540 and the ramped surface 545 faces towards the other of the cassette pieces 530, 532. In certain implementations, the ramped surface 545 is a first ramped surface and the one or more of the latches 540 also includes a second ramped surface 547 that faces in a different direction than the first ramped surface 545. In certain examples, the second ramped surface 547 is angled between 90 degrees and 480 degrees relative to the first ramped surface 545. In certain examples, the second ramped surface 547 is angled between 425 degrees and 445 degrees relative to the first ramped surface. In certain examples, the first ramped surface 545 faces partially towards the front of the cassette 120 and partially outwardly towards one of the sides 506, 508 of the cassette 120. In certain examples, the second ramped surface 547 faces partially outwardly towards one of the sides 506, 508 of the cassette 120 and partially towards a bottom of the cassette 120.

In certain implementations, the ramped surfaces 545, 547 have irregularly shaped surface areas. In certain examples, the first ramped surface 545 is a quadrilateral shape and the second ramped surface 547 is a triangle shape. In certain examples, a transition surface 546 is disposed between the first and second ramped surfaces 545, 547. In certain examples, the transition surface 546 extends at a non-zero angle relative to the flex axis F. In certain examples, the transition surface 546 extends at a non-zero angle relative to the stop surface 543. In certain examples, a second transition surface 548 is disposed between the first ramped surface 545 and the stop surface 543. In certain examples, the second transition surface 548 extends parallel with the flex axis F. In certain examples, the second transition surface 548 extends orthogonal to the stop surface 543.

### ASPECTS OF THE DISCLOSURE

### Aspect 1

A cassette for use in a communications panel, the cassette comprising: a cassette body extending along a depth between a front and a rear, along a width between opposite first and second sides, and along a height between a top and a bottom, the width being perpendicular to the depth, and the height being perpendicular to both the depth and the width; a row of port members carried at the front of the body, each port member defining a front port configured to receive a plug connector, the front ports being accessible from the front of the body; and a cable extending from an interior of the cassette body to an exterior of the cassette body at a location between port members along the row, the cable being movable relative to the cassette body to enable payout of the cable from the cassette body.

### Aspect 2

The cassette of aspect 1, wherein the cable extends between opposite first and second ends, the first end of the cable being located external of the cassette body, the second end of the cable being located within the cassette body, the cable having a bight stored within the cassette body.

### Aspect 3

The cassette of aspect 2, wherein the second end of the cable is connected to the port members of the row.

### Aspect 4

The cassette of aspect 3, wherein each port member defines a rear port that receive a de-mateable connection interface member that terminates part of the second end of the cable.

### Aspect 5

The cassette of any of aspects 1-4, wherein the first end of the cable is terminated at a de-mateable connection interface member that is tethered to the cassette body via the cable.

### Aspect 6

The cassette of any of aspects 1-4, further comprising a strain relief member mounted at the front of the cassette body to be axially stationary relative to the cassette body, the cable passing through the strain relief member as the cable transitions between the interior of the cassette body and the exterior of the cassette body, the cable being axially slidable relative to the strain relief member and relative to the cassette body.

### Aspect 7

The cassette of aspect 6, and preferably of aspects 1 and 6, wherein the strain relief member is a first strain relief member, wherein the cable extends between opposite first and second ends, the first end of the cable being located external of the cassette body, wherein the first end of the cable is terminated at a de-mateable connection interface member, and wherein the de-mateable connection interface member includes a second strain relief member facing in an opposite orientation from the first strain relief member.

### Aspect 8

The cassette of any of aspects 1-7, wherein the body defines a first region and a second region, the second region being disposed rearward of the first region, wherein the second end of the cable is disposed at the first region, and wherein the bight of the cable is disposed at the second region.

### Aspect 9

The cassette of aspect 8, wherein the second region defines a cable management arrangement configured to guide the bight of the cable.

### Aspect 10

The cassette of any of aspects 1-9, wherein the cable extends along a center axis of the cassette body between the second region and the front of the cassette body

### Aspect 11

The cassette of any of aspects 8-10, wherein the first region of the cassette body is defined by a first cassette piece and the second region of the cassette body is defined by a second cassette piece that is removably connected to the first cassette piece.

### Aspect 12

The cassette of aspect 11, wherein the second cassette piece includes protrusions configured to mount at apertures defined by the first cassette piece.

### Aspect 13

The cassette of aspect 12, wherein the protrusions include latch members that deflect along an axis, the axis being parallel with an insertion axis along which the protrusions slide into the apertures when the second cassette piece is mounted to the first cassette piece.

### Aspect 14

The cassette of aspect 13, wherein each latch member includes a first ramped surface facing in a first direction and a second ramped surface facing in a second direction that is angled relative to the first ramped surface at a non-zero angle.

### Aspect 15

The cassette of aspect 14, wherein the first and second ramped surfaces are angled at a 45 degree angle.

### Aspect 16

The cassette of aspect 12, wherein the apertures are sized to receive multi-fiber adapters.

### Aspect 17

A communications panel comprising: a chassis defining an interior; a tray disposed within the interior of the chassis, the tray having a depth extending between a front and a rear of the tray; and a plurality of cassettes mounted to the tray, each cassette including a plurality of de-mateable connection interface locations, and each cassette including a cable carrying signals from the plurality of de-mateable connection interface locations to a connectorized end of the cable, each cable extending out of the respective cassette forwardly of the front of the tray.

### Aspect 18

The communications panel of aspect 17, wherein each cable has a bight that is stored within the respective cassette.

### Aspect 19

The communications panel of aspect 18, wherein each cassette includes a strain relief member through which the respective cable can be paid out.

### Aspect 20

The communications panel of any of aspects 17-19, wherein the cassettes mount to the tray side-by-side in a row.

### Aspect 21

A method of cabling a rack, the method comprising: populating a tray of a chassis with a cassette, the cassette containing a portion of a cable, the cassette including port members at which signals carried by the cable are accessible, the cable having a connectorized end at which the signals carried by the cable also are accessible, the connectorized end being disposed external of the cassette; paying some of the cable from the cassette; and plugging the connectorized end of the cable into another port.

### Aspect 22

The method of aspect 21, wherein the portion of the cable is looped within the cassette.

### Aspect 23

The method of aspect 21, wherein the portion of the cable is wound in a figure-8 configuration within the cassette.

### Aspect 24

The method of aspect 21, wherein populating the tray with the cassette includes sliding the cassette onto the tray until the cassette locks to the tray.

### Aspect 25

A communications arrangement comprising: a tray extending along a forward-rearward axis between a front of the tray and a rear of the tray, the tray carrying a plurality of spaced apart cassette guides extending parallel to each other along the forward-rearward axis of the tray; a cassette configured to mount to the tray, the cassette extending along the forward-rearward axis of the tray between a front of the cassette and a rear of the cassette, the cassette being configured to receive a rear cable or a connectorized end of the rear cable at the rear of the cassette, the cassette being sized to extend from a first of the cassette guides, over a second of the cassette guides, to a third of the cassette guides, the cassette being configured to inter-connect with the first cassette guide and the second cassette guide, but not the third cassette guide; and a cable routing guide mounted to the tray, the cable routing guide defining a cable guide path along the forward-rearward axis of the tray, the cable routing guide defining a front opening leading to the cable guide path at the front of the tray, and the cable routing guide defining a rear opening leading to the cable guide path at the rear of the tray, the rear opening facing at a non-zero angle relative to the forward-rearward axis.

### Aspect 26

The communications arrangement of aspect 25, wherein the rear opening facing orthogonal to the forward-rearward axis.

### Aspect 27

The communications arrangement of aspect 25 or aspect 26, wherein the cable guide path is contoured at the rear of the tray and is straight at the front of the tray.

### Aspect 28

The communications arrangement of any of aspects 25-27, wherein the cable routing guide also includes a protruding guide member extending forwardly from the front of the tray.

### Aspect 29

The communications arrangement of claim 28, wherein the protruding guide member defines a cable passage facing at a non-zero angle relative to the forward-rearward axis.

### Aspect 30

The communications arrangement of claim 29, wherein the cable passage of the protruding guide member faces orthogonal to the forward-rearward axis.

### Aspect 31

The communications arrangement of any of claims 25-30, wherein the cable routing guide is a first cable routing guide mounted to a first side of the tray; and wherein a second cable routing guide is mounted to a second side of the tray opposite the first cable routing guide.

### Aspect 32

The communications arrangement of any of claims 25-31, wherein the cassette is configured to receive a front cable or a connectorized end of the front cable at the front of the cassette.

### Aspect 33

The communications arrangement of claim 32, wherein the cassette carries a plurality of port members, and wherein the front and rear cables are connected together at one or more of the port members.

### Aspect 34

The communications arrangement of claim 33, wherein the port members include a rear port member at which the connectorized end of the rear cable is received.

### Aspect 35

The communications arrangement of claim 33, wherein the port members include a front port member at which the connectorized end of the front cable is received.

### Aspect 36

The communications arrangement of claim 35, wherein the rear cable extends through the rear of the cassette so that the connectorized end of the rear cable is received at the front port member.

### Aspect 37

A communications panel comprising: a chassis defining an interior extending along a depth between a front of the chassis and a rear of the chassis; a plurality of the cassette units disposed within the interior, each cassette unit extending along a depth between a front of the cassette unit and a rear of the cassette unit, each cassette unit including: a cassette configured to receive a rear cable or a connectorized end of the rear cable at a rear of the cassette, each cassette carrying a plurality of front ports at which data signals carried by the rear cable are received, the front ports being disposed at a front of the cassette, and a cassette manager configured to route the rear cable from the rear of the cassette to the front of the cassette unit.

### Aspect 38

The communications panel of claim 37, wherein the cassette is slidably mounted to the cassette manager.

### Aspect 39

The communications panel of claim 37 or claim 38, wherein each cassette manager defines a bend radius limiter extending at least 180 degrees.

### Aspect 40

The communications panel of any of claims 37-39, wherein the cassette manager has opposite first and second major surfaces, and wherein the cassette mounts to the first major surface.

### Aspect 41

The communications panel of claim 40, wherein the cassette manager is configured to route the rear cable over the first major surface.

### Aspect 42

The communications panel of claim 40, wherein the cassette manager is configured to route the rear cable over the second major surface.

### Aspect 43

The communications panel of any of claims 37-42, wherein the cassette units are mounted in a vertical orientation within the chassis.

### Aspect 44

The communications panel of any of claims 37-42, wherein the cassette units are mounted in a horizontal orientation within the chassis.

### Aspect 45

The communications panel of any of claims 37-44, wherein each cassette manager is configured to receive only one cassette.

### Aspect 46

A communications panel comprising: a chassis defining an interior extending along a depth between a front of the chassis and a rear of the chassis; a cassette extending along the forward-rearward axis of the tray element between a front of the cassette and a rear of the cassette, the cassette being configured to receive a rear cable or a connectorized end of the rear cable at the rear of the cassette, each cassette carrying at the front of the cassette a plurality of front ports at which data signals carried by the rear cable are received; and a tray element mountable within the chassis, the tray element extending along a forward-rearward axis between a front of the tray element and a rear of the tray element, the tray element carrying a plurality of spaced apart guides extending parallel to each other along the forward-rearward axis of the tray element, the guides configured to receive the cassette, the tray element also defining a cable guide path extending from the rear of the tray element to the front of the tray element.

### Aspect 47

The communications panel of claim 46, wherein the tray element includes a cassette manager configured to receive only a single cassette.

### Aspect 48

The communications panel of claim 46, wherein the tray element includes a tray configured to receive multiple cassettes.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A communications arrangement comprising:
a tray element extending along a forward-rearward axis between a front of the tray element and a rear of the tray element, the tray element carrying a plurality of spaced apart cassette guides extending parallel to each other along the forward-rearward axis of the tray element;
a cassette configured to mount to the tray element, the cassette extending along the forward-rearward axis of the tray element between a front of the cassette and a rear of the cassette, the cassette including a first guide rail configured to engage with one of the cassette guides of the tray element, the cassette defining a bottom channel extending at least partially along the forward-rearward axis of the tray element, the cassette including a second guide rail disposed in the bottom channel to engage with another of the cassette guides of the tray element, the cassette carrying a port member defining a front port accessible at the front of the tray element; and
a cable guide path defined by at least one of the tray element and the cassette, the cable guide path having a front opening at the front of the tray element, the cable guide path extending along the forward-rearward axis of the tray element past the port member of the cassette and towards the rear of the cassette.

2. The communications arrangement of claim 1, wherein the tray element includes a tray.

3. The communications arrangement of claim 2, wherein the cassette includes a first portion and a second portion, the first portion being located closer to the front of the tray than the second portion, the first portion of the cassette holding the port member; and the second portion of the cassette defining a cable storage region, the cable guide path extending between the cable storage region and the front of the cassette.

4. The communications arrangement of claim 2, or further comprising a cable extending from an interior of the cassette to an exterior of the cassette, the cable being movable relative to the cassette to enable payout of the cable from the cassette.

5. The communications arrangement of claim 4, wherein the port member is one of a plurality of port members carried by the cassette, and wherein the cable extends outwardly from the cassette between the port members.

6. The communications arrangement of claim 2, wherein the tray element includes a cable routing guide defining the cable guide path, wherein the cable guide path extends from the front opening to a rear opening, the rear opening facing orthogonal to the forward-rearward axis of the tray element.

7. The communications arrangement of claim 6, wherein the cable routing guide is a first cable routing guide mounted to a first side of the tray element; and wherein a second cable routing guide is mounted to a second side of the tray element opposite the first cable routing guide.

8. The communications arrangement of claim 2, wherein the tray element includes a cassette manager configured to receive only a single cassette, wherein the cassette manager has opposite first and second major surfaces, and wherein the cassette mounts to the first major surface.

9. The communications panel of claim 8, wherein the cassette manager is configured to route the rear cable over the first major surface.

10. The communications panel of claim 8, wherein the cassette manager is configured to route the rear cable over the second major surface.

11. The communications arrangement of claim 10, wherein the cable routing guide also includes a protruding guide member extending forwardly from the front of the tray, the protruding guide member defining a cable passage facing at a non-zero angle relative to the forward-rearward axis.

12. The communications arrangement of claim 8, wherein each cassette manager defines a bend radius limiter along the cable guide path, the bend radius limiter extending at least 180 degrees.

13. The communications arrangement of claim 6, wherein the cable guide path is contoured at the rear of the tray element and is straight at the front of the tray element.

14. The communications arrangement of any claim 6, further comprising a first cable disposed along the cable guide path, the first cable having a first end that extends outwardly from the front opening of the cable guide path at the front of the tray element, the first cable being coupled to the cassette so that signals carried over the first cable are accessible at the front port of the port member of the cassette.

15. The communications arrangement of claim 14, wherein the front port of the port member of the cassette is configured to receive a second cable or a connectorized end of the second cable, wherein the cassette carries a plurality of port members, and wherein the first and second cables are connected together at one or more of the port members.

16. The communications arrangement of claim 1, wherein the cassette is slidably mounted to the tray element.

17. A cassette for use in a communications panel, the cassette comprising:
a cassette body extending along a depth between a front and a rear, along a width between opposite first and second sides, and along a height between a top and a bottom, the width being perpendicular to the depth, and the height being perpendicular to both the depth and the width;
a row of port members carried at the front of the body, each port member defining a front port configured to receive a plug connector, the front ports being accessible from the front of the body; and
a cable extending from an interior of the cassette body to an exterior of the cassette body at a location between port members along the row, the cable being movable relative to the cassette body to enable payout of the cable from the cassette body.

18. The cassette of claim 17, wherein the cassette defines a first region and a second region, the second region being disposed rearward of the first region, wherein the second end of the cable is disposed at the first region, and wherein the bight of the cable is disposed at the second region.

19. The cassette of claim 18, wherein the first region of the cassette body is defined by a first cassette piece and the second region of the cassette body is defined by a second cassette piece that is removably connected to the first cassette piece.

20. The cassette of claim 19, wherein the second cassette piece includes protrusions configured to mount at apertures defined by the first cassette piece, wherein the protrusions include latch members that deflect along an axis, the axis being parallel with an insertion axis along which the protrusions slide into the apertures when the second cassette piece is mounted to the first cassette piece, wherein each latch member includes a first ramped surface facing in a first direction and a second ramped surface facing in a second direction that is angled relative to the first ramped surface at a non-zero angle.

21. The cassette of claim 20, wherein the first and second ramped surfaces are angled at a 45 degree angle.

22. The cassette of claim 20, wherein the apertures are sized to receive multi-fiber adapters.

23. The cassette of claim 18, wherein the second region defines a cable management arrangement configured to guide the bight of the cable.

24. The cassette of claim 18, wherein the cable extends along a center axis of the cassette body between the second region and the front of the cassette body.

25. The cassette of claim 17, wherein the cable extends between opposite first and second ends, the first end of the cable being located external of the cassette body, the second end of the cable being located within the cassette body, the cable having a bight stored within the cassette body.

26. The cassette of claim 25, wherein the first end of the cable is terminated at a de-mateable connection interface member that is tethered to the cassette body via the cable.

27. The cassette of claim 17, further comprising a strain relief member mounted at the front of the cassette to be axially stationary relative to the cassette, the cable passing through the strain relief member as the cable transitions between the interior of the cassette and the exterior of the cassette, the cable being axially slidable relative to the strain relief member and relative to the cassette.

28. A method of cabling a rack, the method comprising:
populating a tray of a chassis with a cassette, the cassette containing a portion of a cable, the cassette including port members at which signals carried by the cable are accessible, the cable having a connectorized end at which the signals carried by the cable also are accessible, the connectorized end being disposed external of the cassette;
paying some of the cable from the cassette; and
plugging the connectorized end of the cable into another port.

29. The method of claim 28, wherein populating the tray with the cassette includes sliding the cassette onto the tray until the cassette locks to the tray.
